(19) United States
(12) Patent Application Publication
(10) Pub. No.: US 2006/0058999 A1
(43) Pub. Date: Mar. 16, 2006

(54) Voice model adaptation

(76) Inventors: Simon Barker, Watertown, MA (US); Valerie L. Beattie, Macungie, PA (US)

Correspondence Address: FISH & RICHARDSON PC, P.O. BOX 1022, MINNEAPOLIS, MN, 55440-1022, US

(21) Appl. No.: 10/938,758

(22) Filed: Sep. 10, 2004

(51) Int. Cl. G10L 15/14

(52) U.S. Cl. 704/256

(57) ABSTRACT

Voice recognition tutoring software to assist in reading development includes method and system for generating a custom voice model.

### BACKGROUND

Reading software focuses on increasing reading skills of a user and uses voice recognition to determine if a user correctly reads a passage. Reading software that assesses audio or speech input from a user often relies on an underlying voice model used by a speech recognition program. The voice model provides a standard representation of sounds (e.g., phonemes) to which the speech recognition program compares user input to determine if the input is correct.

### SUMMARY

In one aspect, a method for generating a custom voice model includes receiving audio input from a user and comparing the received audio input to an expected input. The expected input is determined based on an initial or default voice model. The method also includes determining a number of words read incorrectly in a sentence or portion of the passage and adding the sentence audio data to a set of data for producing the custom voice model if the number of words read incorrectly is less than a threshold value.

Embodiments can include one or more of the following.

The method can include determining a number of words read incorrectly based on a subset of words from the passage. The method can include signaling the user to re-read a sentence if the number of words read incorrectly is greater than the threshold value.

The method can include playing a recorded reading of the sentence or of a portion of the sentence, and indicating that the user should repeat what they hear. The audio can be used to signal the user to re-read the sentence if the number of words read incorrectly is greater than the threshold value. The method can include receiving input from the user related to the re-read sentence and determining a number of words read incorrectly in the re-read sentence. The method can also include proceeding to the next sentence without adding the re-read sentence audio data to the set of data for producing the custom voice model, if the number of words read incorrectly is greater than the threshold value. The method can include determining the number of sentences that have been included in the set of data for producing the custom voice model, and aborting the generation of a custom voice model if the number of sentences is less than a threshold. The method can include playing a recorded reading of a sentence based upon user request, either before the user starts reading the passage or after the user has requested to pause the reading of the passage and associated audio collection.

In another aspect, a method for generating a custom voice model includes using an existing model to determine if a received audio input matches an expected input. A new model is estimated based on the received audio input. The expected input is represented by a sequence of phones, e.g. single speech sounds considered as a physical event without reference to the physical event's place in the structure of a language. Each phone is modeled by a sequence of Hidden Markov Model (HMM) states whose output distributions are represented by a weighted mixture of Gaussian or Normal distributions. Each of the Gaussian distributions is parameterized by a mean vector and covariance matrix. The method includes aligning the received audio against the expected sequence of HMM states and using this alignment to re-estimate the observed HMM output distribution parameters. For example, the Normal distribution arithmetic means and co-variances can be re-estimated to produce the custom voice model.

The method can include storing the custom Gaussian voice model. Receiving audio input can include receiving less than about 100 words of audio input or less than the amount of audio input associated with one page of text. Both the variance and the arithmetic mean can be adjusted. Analyzing phonemes to adjust the mean and/or variance can include calculating a new variance and arithmetic mean based on the received audio. In another aspect, analyzing can include calculating a new variance and arithmetic mean based on the received audio and merging or combining the calculated variance and arithmetic mean with the original variance and arithmetic mean for the Gaussian to determine a custom voice model.

In another aspect, a device is configured to receive audio input from a user and compare the received audio input to an expected input that is determined based on an initial or default voice model. The device is further configured to determine a number of words read incorrectly in a sentence and add the sentence audio data to the set of data for producing a custom voice model if the number of words read incorrectly is less than a threshold value.

Embodiments can include one or more of the following.

The device can be configured to determine a number of words read incorrectly based on a subset of less than all of the words from the passage. The device can be configured to signal the user to re-read a sentence if the number of words read incorrectly is greater than the threshold value. The device can be configured to receive input from the user related to the re-read sentence and determine a number of words read incorrectly in the re-read sentence. The device can be further configured to proceed to the next sentence without adding the re-read sentence audio data to the set of data for producing the custom voice model, if the number of words read incorrectly is greater than the threshold value.

In another aspect, a device is configured to determine if received audio input matches an expected input. The expected input is represented by a sequence of phones with each phone represented by a HMM whose output distributions consist of a weighted mixture of Gaussian or Normal distributions.

Each of the Gaussian functions has a weight factor, an arithmetic mean, and a variance. The device is configured to decompose the received audio input into phonemes and analyze the phonemes to adjust at least one of the variance and the arithmetic mean without adjusting the weight factor for at least one of the Gaussian distributions to produce the custom voice model.

Embodiments can include one or more of the following.

The device can be configured to adjust both the variance and the arithmetic mean. The device can be configured to calculate a new variance and arithmetic mean based on the received audio. The device can be configured to calculate a new variance and arithmetic mean based on the received audio and average the calculated variance and arithmetic mean with the original variance and arithmetic mean for the Gaussian to determine a custom voice model.

In another aspect, a computer program product is tangibly embodied in an information carrier, for executing instructions on a processor. The computer program product can be operable to cause a computer to receive audio input from a user and compare the received audio input to an expected input. The expected input can be determined based on an initial or default voice model. In addition, the computer program product can include instructions to determine a number of words read incorrectly in a sentence of the passage and add the sentence audio data to the set of data for producing a custom voice model if the number of words read incorrectly is less than a threshold value.

Embodiments can include one or more of the following.

The computer program product can include instructions to determine a number of words read incorrectly based on a subset of less than all of the words from the passage. The computer program product can include instructions to signal the user to re-read a sentence if the number of words read incorrectly is greater than the threshold value. The computer program product can include instructions to receive input from the user related to the re-read sentence, determine a number of words read incorrectly in the re-read sentence, and proceed to the next sentence without adding the re-read sentence audio data to the set of data for producing the custom voice model, if the number of words read incorrectly is greater than the threshold value.

In another aspect, a computer program product is tangibly embodied in an information carrier, for executing instructions on a processor. The computer program product can be operable to cause a machine to determine if a received audio input matches an expected input. The expected input can be represented by a set of phonemes with at least some of the phonemes represented by a plurality of Gaussian functions. Each of the Gaussian functions has a weight factor, an arithmetic mean, and a variance. The computer program product can include instructions to decompose the received audio input into phonemes and analyze the phonemes to adjust at least one of the variance and the arithmetic mean without adjusting the weight factor for at least one of the Gaussian functions for a particular phoneme to produce the custom Gaussian voice model. In addition, the computer program product can include instructions to store the custom Gaussian voice model.

Embodiments can include one or more of the following.

The computer program product can include instructions to adjust both the variance and the arithmetic mean. The computer program product can include instructions to calculate a new variance and arithmetic mean based on the received audio.

### DESCRIPTION OF DRAWINGS

FIG. 1 is a block diagram of a computer system adapted for reading tutoring.

FIG. 2 is a block diagram of a network of computer systems.

FIG. 3 is a block diagram of a speech recognition process.

FIG. 4 is a screenshot of a set-up screen for reading tutor software.

FIG. 5 is a screenshot of a custom voice profile set-up screen.

FIG. 6 is a screenshot of a passage used for custom voice profile training.

FIGS. 7A and 7B are flow charts of a custom voice profile training process.

FIG. 8 is a flow chart of a voice model adaptation process.

FIGS. 9A and 9B are block diagrams of the division of a word into phonemes, states, and an underlying set of Gaussians.

FIG. 10 is a block diagram of an algorithm used in custom voice profile training.

### DESCRIPTION

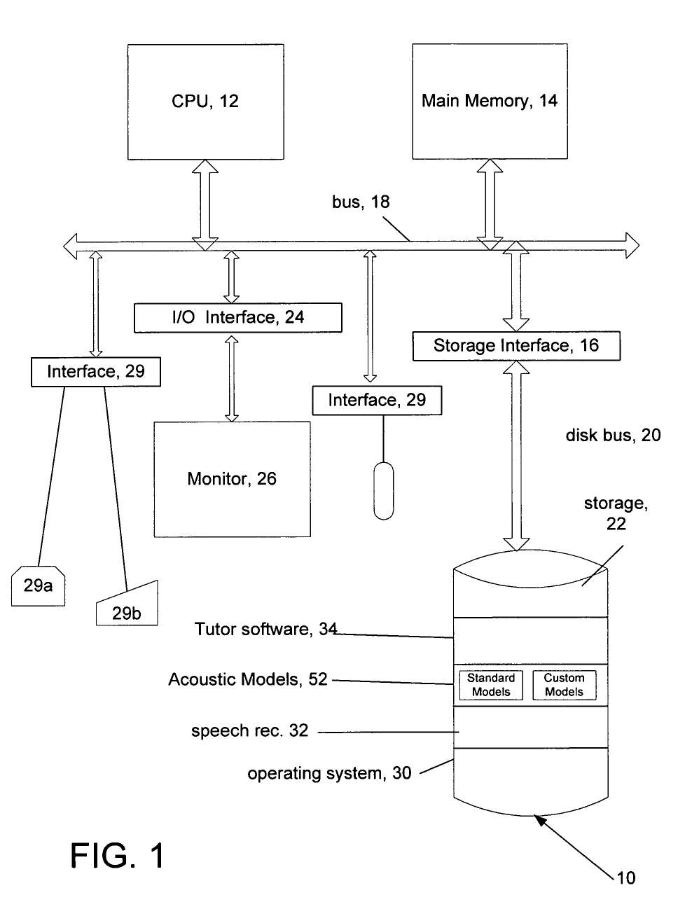

Referring to FIG. 1, a computer system 10 includes a processor 12, main memory 14, and storage interface 16 all coupled via a system bus 18. The interface 16 interfaces system bus 18 with a disk or storage bus 20 and couples a disk or storage media 22 to the computer system 10. The computer system 10 would also include an optical disc drive or the like coupled to the bus via another interface (not shown). Similarly, an interface 24 couples a monitor or display device 26 to the system 10. Other arrangements of system 10, of course, could be used and generally, system 10 represents the configuration of any typical personal computer. Disk 22 has stored thereon software for execution by a processor 12 using memory 14. Additionally, an interface 29 couples user devices such as a mouse 29a and a microphone/headset 29b, and can include a keyboard (not shown) attached to the bus 18.

The software includes an operating system 30 which can be any operating system, speech recognition software 32 which can be any system such as the Sphinx II open source recognition engine or any engine that provides sufficient access to recognizer functionality and uses a semi-continuous acoustic model and tutoring software 34 which will be discussed below. The reading tutor software 34 is useful in developing reading fluency. The software also includes a set of acoustic models 52 used by the speech recognition engine and the tutor software 34 in assessing fluency. The acoustic models 52 can include standard acoustic models and custom acoustic models or voice profiles. The custom acoustic models are acoustic models adapted to the speech of a particular user. A user would interact with the computer system principally though mouse 29a and microphone/headset 29b.

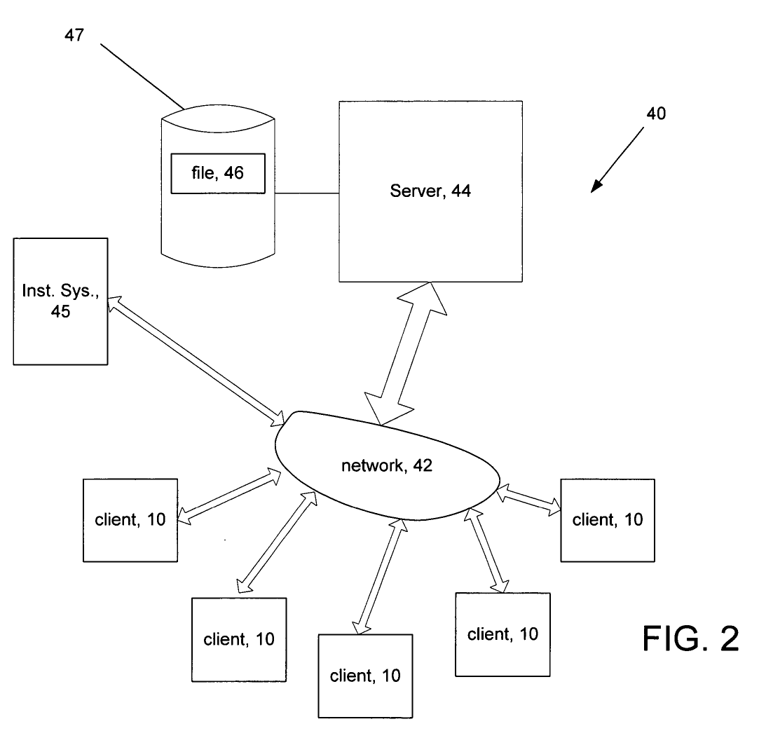

Referring now to FIG. 2, a network arrangement 40 of systems 10 is shown. This configuration is especially useful in a classroom environment where a teacher, for example, can monitor the progress of multiple students. The arrangement 40 includes multiple ones of the systems 10 or equivalents thereof coupled via a local area network, the Internet, a wide-area network, or an Intranet 42 to a server computer 44. An instructor system 45 similar in construction to the system 10 is coupled to the server 44 to enable an instructor and so forth access to the server 44. The instructor system 45 enables an instructor to import student rosters, set up student accounts, adjust system parameters as necessary for each student, track and review student performance, and optionally, to define awards.

The server computer 44 would include amongst other things a file 46 stored, e.g., on storage device 47, which holds aggregated data generated by the computer systems 10 through use by students executing software 34. The files 46 can include text-based results from execution of the tutoring software 34 as will be described below. Also residing on the storage device 47 can be individual speech files resulting from execution of the tutor software 34 on the systems 10. In other embodiments, the speech files being rather large in size would reside on the individual systems 10. Thus, in a classroom setting an instructor can access the text based files over the server via system 45, and can individually visit a student system 10 to play back audio from the speech files if necessary. Alternatively, in some embodiments the speech files can be selectively downloaded to the server 44.

Like many advanced skills, reading depends on a collection of underlying skills and capabilities. The tutoring software 34 fits into development of reading skills based on existence of interdependent areas such as physical capabilities, sensory processing capabilities, and language and reading skills. In order for a person to learn to read written text, the eyes need to focus properly and the brain needs to properly process resulting visual information. The person develops an understanding of language, usually through hearing language, which requires that the ear mechanics work properly and the brain processes auditory information properly. Speaking also contributes strongly to development of language skills, but speech requires its own mechanical and mental processing capabilities. Before learning to read, a person should have the basic language skills typically acquired during normal development and should learn basic phoneme awareness, the alphabet, and basic phonics. In a typical classroom setting, a person should have the physical and emotional capability to sit still and “tune out” distractions and focus on a task at hand. With all of these skills and capabilities in place, a person can begin to learn to read fluently, with comprehension, and to develop a broad vocabulary.

The tutor software 34 described below is particularly useful once a user has developed proper body mechanics and the sensory processing, and the user has acquired basic language, alphabet, and phonics skills. The tutor software 34 can improve reading comprehension, which depends heavily on reading fluency. The tutor software 34 can develop fluency by supporting frequent and repeated oral reading. The reading tutor software 34 provides this frequent and repeated supported oral reading, using speech recognition technology to listen to the student read and provide help when the student struggles. In addition, reading tutor software 34 can assist in vocabulary development. The software 34 can be used with users of all ages and especially children in early though advanced stages of reading development.

Vocabulary, fluency, and comprehension all interact as a person learns. The more a person reads, the more fluent the person becomes, and the more vocabulary the person learns. As a person becomes more fluent and develops a broader vocabulary, the person reads more easily.

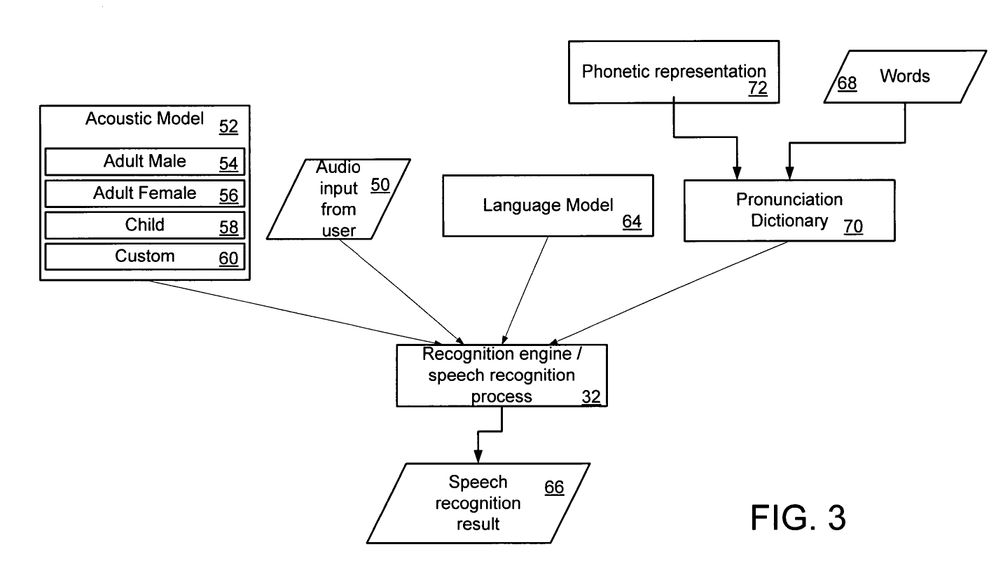

Referring to FIG. 3, the speech recognition engine 32 in combination with the tutor software 34 analyzes speech or audio input 50 from the user and generates a speech recognition result 66. The speech recognition engine uses an acoustic model 52, a language model 64, and a pronunciation dictionary 70 to generate the speech recognition result 66 for the audio input 50.

The acoustic model 52 represents the sounds of speech (e.g., phonemes). Due to differences in speech for different groups of people or for individual users, the speech recognition engine 32 includes multiple acoustic models 52 such as an adult male acoustic model 54, an adult female acoustic model 56, a child acoustic model 58, and a custom acoustic model 60. In addition, although not shown in FIG. 3, acoustic models for various ethnic groups or acoustic models representing the speech of users for which English is a second language could be included. A particular one of the acoustic models 52 is used to process audio input 50 and identify acoustic content of the audio input 50.

The pronunciation dictionary 70 is based on words 68 and phonetic representations. The words 68 come from the story texts or passages, and the phonetic representations 72 are generated based on human speech input or knowledge of how the words are pronounced. In addition, the pronunciations or phonetic representations of words can be obtained from existing databases of words and their associated pronunciations. Both the pronunciation dictionary 70 and the language model 64 are associated with the story texts to be recognized. For the pronunciation dictionary 72, the words are taken independently from the story text. In contrast, the language model 64 is based on sequences of words from the story text or passage. The recognizer uses the language model 64 and the dictionary 70 to constrain the recognition search and determine what is considered from the acoustic model when processing the audio input from the user 50. In general, the speech recognition process 32 uses the acoustic model 52, the language model 64, and the pronunciation dictionary 70 to generate the speech recognition result 66.

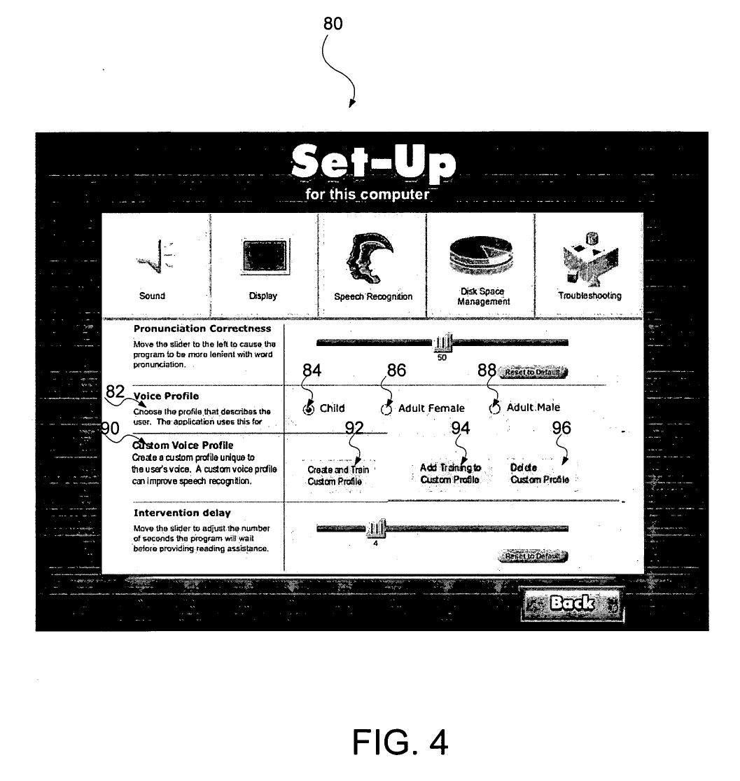

Referring to FIG. 4, a screenshot shows a user interface for a reading tutor software setup screen 80 accessed by the user to set preferred settings for the tutor software 34 and recognition engine 32. Among other items available for customization, a user can select a voice profile (e.g., an acoustic model) that most closely describes the user. In setup screen 80, the user can select a voice profile for a child 84, adult female 86, or adult male 88, for example. The voice profile or acoustic model is used in the assessment of the user's speech input. The representations phonemes can differ between the models 84, 86, or 88. Thus, it can be advantageous to select a voice profile or acoustic model that most closely matches the speech patterns of the user.

In addition to selecting a representative voice profile 84, 86, or 88, a user can generate a custom acoustic model 60 by selecting one of the options in the custom voice profile section 90 of setup screen 80. To begin set-up of a custom voice model, the user selects button 92 to train the custom model. If a custom model has previously been generated for the user, the user selects button 94 to add additional training to the previously generated custom model. In addition, the user can delete a previously generated custom model by selecting button 96.

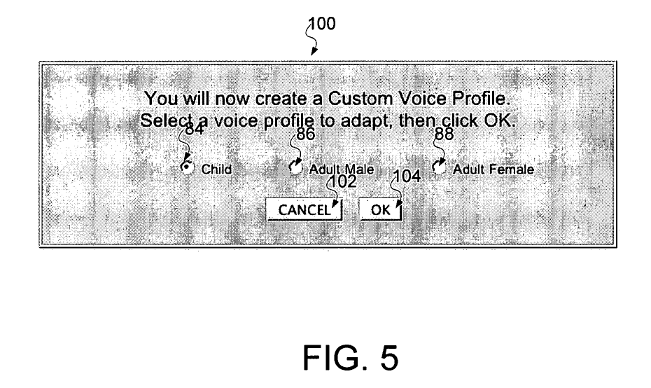

Referring to FIG. 5, in response to a user selecting option 92 on setup screen 80, the user generates a custom voice model. The user selects a voice model 84, 86, or 88 that will be adapted to generate the custom voice model. Adapting a model that most closely represents the peer group of the user allows the speech recognition program to generate a custom model that more closely represents the user's voice/speech based on limited input. For example, a five year old child's speech would more closely match the voice model for a child and, thus, the amount of adaptation needed to generate a custom voice model would be less using the child acoustic model than the adult male acoustic model.

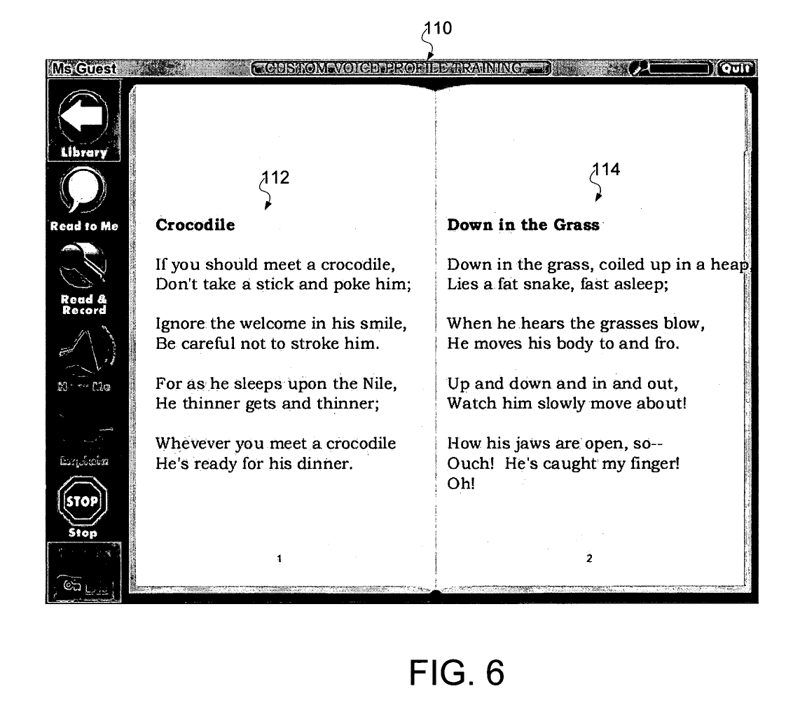

Referring to FIG. 6, a screenshot 110 of a user interface including two reading passages 112 and 114 for custom voice profile training is shown. In order to generate an accurate custom voice model, the user reads one or more of passages 112 and 114 (or other passages). Based on the user input, the speech recognition engine adjusts the underlying custom voice model to represent the voice model for the user.

In order to obtain accurate acoustic representations of the phonemes for a particular user's speech, accurate or semi-accurate speech input is needed from the user. When the speech acoustic model is adapted for use with reading tutor software, the speech input received to modify the voice model can be limited. For example, the passages (e.g., passages 112 and 114) presented to the user to read may be short (e.g., less than about 100-150 words). However, the passage could be greater than 150 words but still be relatively short in length (e.g., the passage could be about 1-2 pages in length). However, other lengths of passages are possible. In addition, the passages presented to the user may be at or below the user's current reading level. By selecting passages at or below a user's reading level, it is more probable that the received pronunciations for the words are accurate. In addition to selecting a passage based on a skill level of the user and a length of the passage, the text of the passage can be selected based on the phonemes included in the text. For example, a text with multiple occurrences of different phonemes allows the voice model for the phonemes to be adjusted with increased accuracy.

Due to the length of the passages presented to the user, a limited amount of data is available to the speech recognition engine for adjusting the voice model. Based on the limited data, the speech recognition engine uses a statistical method (e.g., a Bayesian method) to adjust the underlying arithmetic means and variances for Gaussians in the voice model (as described below). In addition, since the data is limited, in some embodiments the speech recognition engine merges or averages a calculated model based on the user input with the original voice model to produce the custom voice model. Thus, the custom model may be a variation of a previously stored model and not generally based solely on the received audio.

In order to generate an accurate acoustic model for a system used by children, for example, accurate or robust data collection should be maintained. However, children (or other users) struggling to read a passage are required by an adaptation algorithm to read the passage in order to allow the system to compute new models thus, increasing the difficulty of receiving accurate or robust data. The adaptation system in the tutor software and voice recognition system handles reading errors in a manner that allows the voice recognition system to collect a reasonable amount of audio data without frustrating the child (or other user).

The system allows up to, e.g., two reader errors in content words per 150 words. As described above, the user or child reads a short (e.g., less than about 150 words) passage with a reading level below the user's current reading level. In some embodiments, the system also allows common words in the passage to be misspoken or omitted. If errors are detected in the child's reading, the system allows the child to read the sentence again. If the user still appears to have difficulty, then the sentence is read to the user and the user is given a further chance to read the passage back to the system.

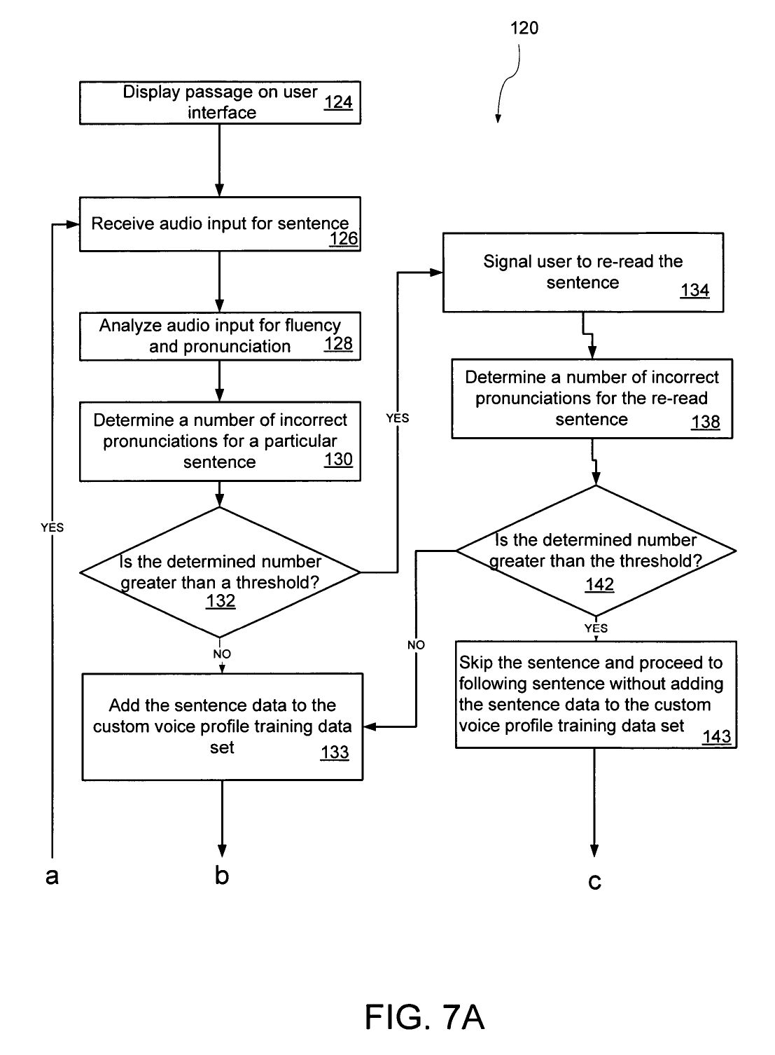

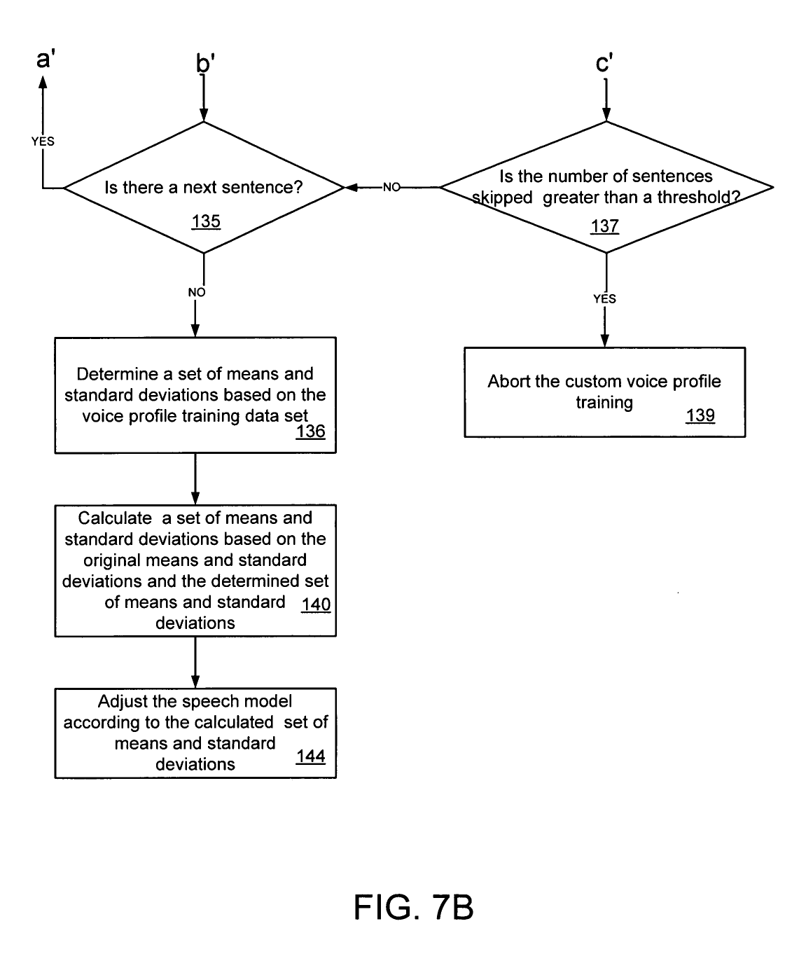

Referring to FIG. 7, a process 120 for adapting a speech model based on user input is shown. Process 120 is used in the speech training or voice model adaptation mode of the tutor software. Process 120 includes displaying 124 a passage to a user on a user interface. Process 120 receives 126 audio input from the user reading a set of the words in the passage (e.g., a sentence) and analyzes 128 the audio input for fluency and pronunciation. Process 120 determines 130 a number of incorrect pronunciations for a particular portion of the passage (e.g., for the sentence) and determines 132 if the number of errors is greater than a threshold. The threshold can vary based on the length of the portion or sentence.

If the number of errors is determined 132 to be greater than the threshold, the input for that reading of the sentence is not used to adapt the voice model and the user is prompted 134 to re-read the sentence. Process 120 determines 138 a number of incorrect pronunciations for the re-read sentence and determines 142 if the number of incorrect pronunciations in the re-read sentence is greater than the threshold. If the number of errors is determined 142 to be greater than the threshold, the sentence is skipped 143 and the process proceeds to the following sentence without adding the sentence data to the custom voice profile training data set. Process 120 subsequently determines 137 if the number of sentences that have been skipped is greater than a threshold. If the total number of sentences skipped is greater than the threshold, the speech model will not be adjusted and process 120 aborts 139 the custom voice profile training.

If the number of pronunciation errors for a sentence is determined 132 to be less than the threshold, the sentence data is added 133 to the custom voice profile training data set.

Subsequent to either sentence data being added 133 to the voice profile training data set or after a sentence has been skipped but the total number of sentences skipped had been determined 137 to be less than the threshold, the voice profile training process determines 135 if there is a next sentence in the passage. If there is a next sentence, process 120 returns to receiving audio input 126 for the subsequent sentence. If the user has reached the end of the passage (e.g., there is not a next sentence), process 120 determines 136, based on the voice profile training data set, a set of arithmetic means and standard deviations for Gaussian models used in a representation of the phonemes detected in the received utterances. Process 120 calculates 140 a set of arithmetic means and standard deviations for the custom model based on the original or previously stored arithmetic means and deviations and the arithmetic means and deviations determined from the user input. Process 120 adjusts 144 the original model based on the calculated set of arithmetic means and standard deviations for the custom model and stores the adjusted original model as the custom speech model for the user.

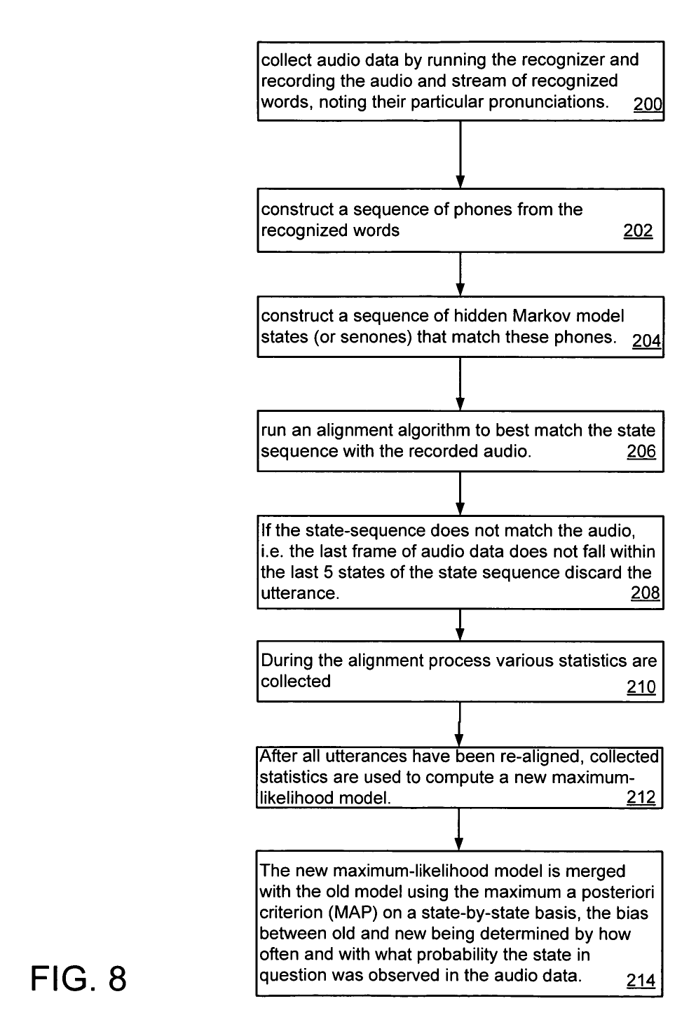

Referring to FIG. 8, a process 199 for adapting a voice profile is shown (details of various steps of process 199 are described below). To adapt a voice profile, process 199 includes collecting 200 audio data by running the recognizer and recording the audio and stream of recognized words, noting their particular pronunciations. For the recognized words, the recognizer constructs 202 a sequence of phones from each of the recognized words. Process 199 also constructs 204 a sequence of hidden Markov model states (or senones) that match the phones for the recognized words. An alignment algorithm is run 206 to best match the state sequence with the recorded audio. If the state-sequence does not match the audio, e.g., the last frame of audio data does not fall within the last 5 states of the state sequence the voice model adaptation process discards 208 the utterance. During the alignment process, the model adaptation process collects 210 various statistics based on the received audio. Subsequent to the re-alignment, the voice model adaptation process uses the collected statistics to compute 212 a new maximum-likelihood model. The computed maximum-likelihood model is merged 214 with the previous or original model using the maximum a posteriori criterion (MAP) on a state-by-state basis. The bias between the old voice model and the new voice model adaptation process is determined by how often and with what probability a particular state was observed in the audio data.

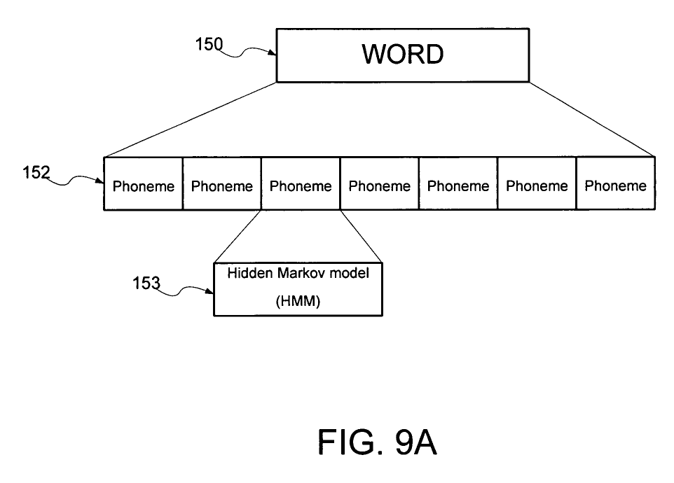

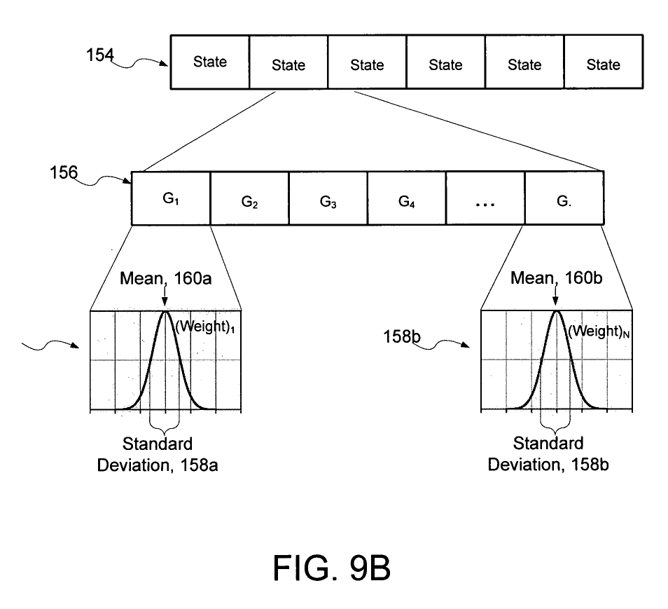

Referring to FIG. 9A, a representation of a word 150 in the speech model is shown. The word 150 is represented by a sequence of phonemes 152. Each phone 152 is modeled as a hidden-Markov model (HMMs) 153. The HMMs can include multiple states and each state of a hidden-Markov model has an output distribution relating it to a feature vector derived from the input audio stream.

Referring to FIG. 9B, the HMMs have multiple states and a set of states 154 is shared over all the different HMMs 153 over all the phones 152. The states are also referred to as senones. Each senone (or state 154) has an output distribution of a weighted mixture of Gaussian or Normal distributions. There is a single set of Gaussian distributions that is shared over all the states 154, but for each state the mixture weights are different. Each Gaussian distribution 156 is parameterized by a mean vector and a co-variance vector (the co-variance matrix is diagonal). The set of Gaussian functions can therefore, be parameterized by a set of mean and co-variance vectors referred to as the codebook. The codebook includes 256 code-words. In order to adapt the voice model or estimate a new acoustic model, the 256 mean and co-variance vectors are re-estimated based on the audio received from the user. The mixture weights are not re-estimated due to the limited amount of training data.

Two examples of speech models that can be used by a speech recognition program include semi-continuous acoustic models and continuous acoustic models. Adaptation of a semi-continuous hidden Markov (HMM) acoustic model for a speech recognition program differs from the adaptation of a fully-continuous model. For example, adaptation algorithms derived for a fully continuous recognizer may use techniques such as maximum-likelihood linear regression (MLLR). Because of the small amounts of data used to adjust the voice model, the fully continuous model space can be partitioned into clusters of arithmetic mean vectors whose affine transforms are calculated individually. In a semi-continuous model, such partitions may not readily exist. In a continuous model, the output density comprises weighted sum of multidimensional Gaussian density functions as shown in equation (1):

$${o}_{s} ( {x}_{t} ) = {\sum }_{k = 1}^{M} {w}_{sk} N ( {x}_{t} \vert {μ}_{sk} , {Σ}_{sk} ) \qquad ( 1 )$$

For each state ‘s’ in the hidden Markov model (HMM) there exists an associated set of M weights and Gaussian density functions that define an output probability. For a semi-continuous model the Gaussian density functions are shared across multiple states, effectively generating a pool of shared Gaussian distributions. Thus, a state is represented by the weights given to distributions as shown in equation (2):

$${o}_{s} ( {x}_{t} ) = {\sum }_{k = l}^{M} {w}_{sk} N ( {x}_{t} \vert {μ}_{k} , {Σ}_{k} ) \qquad ( 2 )$$

For example, in one embodiment, 256 mean vectors and diagonal covariance matrices are used in a process to partition the feature space into distinct regions. For example, the feature space is spanned by the feature vectors. The feature space can be a 55 dimensional space, including the real spectrum coefficients, and the delta and double deltas of these coefficients plus three power features. In the case of a fully-continuous HMM it is therefore possible to apply a number of differing affine transforms to subsets of the density mean/covariance vectors effectively altering the partitioning of the feature space. States are usually divided into subsets using phonologically based rules or by applying clustering techniques to the central moments for the respective models.

As described above, because the semi-continuous model shares a limited number of Gaussian densities between multiple states, clustering the underlying Gaussian distributions is not easily accomplished. In addition, a useful partitioning can be unlikely due to the small number of distributions (e.g., 256 distributions).

It can be advantageous to re-estimate the free parameters in the continuous HMM model from a small amount of data. The free parameters are the codebook, arithmetic means and variances estimated to arrive at the acoustic model. In some embodiments, the codebook is limited to 256 entries, thus, only 256×55 mean elements have to be estimated and a like number of variances. In a fully continuous model, the number of free parameters is much higher because there is no codebook. For example, in the fully continuous model each state has its own set of mean and variance vectors, so given there are 5000-6000 states each would have maybe 50 mean and covariance vectors the number of parameters to be estimated in this case is much higher. Due to the high number of parameters, it may not be desirable to use an algorithm such as MLLR. As described above, for the semi-continuous model the number of free parameters is much smaller than for the fully-continuous model. Thus, it is possible to apply a maximum a posteriori (MAP) model estimation criterion directly, even with relatively small amounts of adaptation data, as discussed below.

If large quantities of audio adaptation data are available (e.g. 10-30 minutes of audio input), the voice model can be adapted by modifying the mixture weights WSk. However, in a 100-300 word story, adjusting the weights generally does not provide adequate state coverage. For example, the model may be adapted based on one or two samples, reducing the reliability of the estimate.

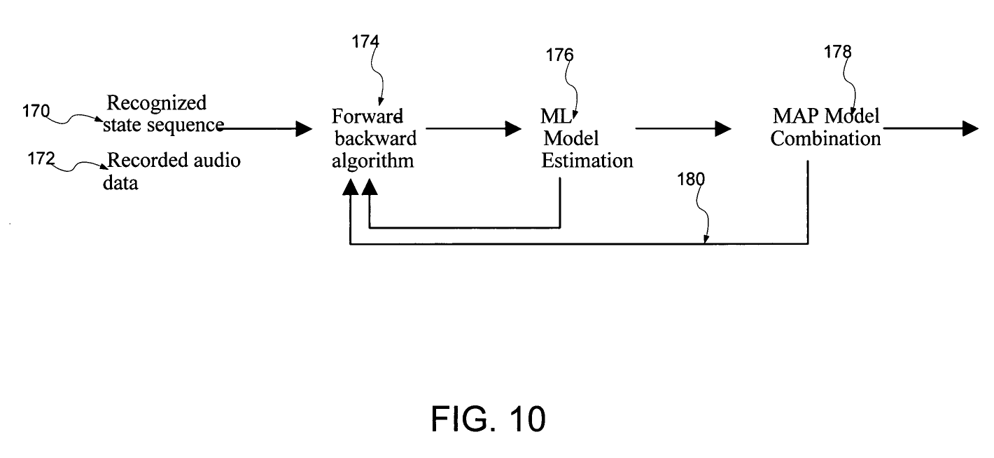

The output of data collection for rapid adaptation is a collection of audio data and the recognizer's state word level transcription pertaining to each sentence recorded. The adaptation algorithm takes this data and uses a Forward-Backward algorithm (see FIG. 10) to compute the necessary statistics for the acoustic model (e.g., arithmetic means and co-variances). This speaker-dependent model is combined with the original speaker independent model, for example, using the MAP criterion.

The adaptation process follows the schematic shown in FIG. 9. Inputs to the process are the recognized state sequence 170 and audio data 172 in addition to the initial acoustic model. The forward backward algorithm 174 is applied to these inputs to generate the necessary statistics (described below) for ML model estimation 176. The ML model may be used to facilitate further iteration of forward-backward/model estimation steps. The original acoustic model is combined with the ML estimate according to probabilistic weights, this is the MAP (maximum a posteriori) model estimation 178 (e.g., the combination of the a prioiri information, the original speaker independent model with the learned data to generate the ML speaker dependent model). In some embodiments, an additional linkage, feedback 180 from the MAP model to forward backward algorithm provides a further iteration.

In order to reduce the computational intensity in generating the custom voice model, the speech recognition software may consider a set of the most probable Gaussians (e.g., the top four most probable Gaussians) when evaluating output probabilities for each state. If four Gaussians are used, the output probability is given by equation (3) as:

$${o}_{s} ( {x}_{t} ) = {\sum }_{k ∈ η ( {x}_{t} )} {w}_{sk} N ( {x}_{t} \vert {μ}_{k} , {Σ}_{k} ) \qquad ( 3 )$$

where η(xₜ) denotes the set of most probable Gaussian indices. To derive an expression for the ML model estimate for the semi-continuous mixture model, standard parameters of the forward-backward or Baum-Welch algorithm for the continuous model are defined according to the equations (4) to (7) below:
   αₜ(i)=p(x₁,x₂, . . . ,xₜ,sₜ=i|Φ) (4)
   βₜ(i)=p(xₜ,xₜ₊₁, . . . ,x_{T},sₜ=i|Φ) (5)
   γₜ(i,j)=p(sₜ₋₁=i,sₜ=j|x₁,x₂, . . . ,x_{T},Φ) (6)
   ζₜ(i,k)=p(sₜ=i,kₜ=k|x₁,x₂, . . . ,x_{T},Φ) (7)
where Φ is the set of model parameters. Model estimates can be derived from these quantities as shown in equations (8) and (9) below:

$$\begin{matrix}\begin{matrix}{\hat{μ}}_{ik} = \frac{{\sum }_{t = 1}^{T} {ζ}_{t} ( i , k ) {x}_{t}}{{\sum }_{t = 1}^{T} {ζ}_{t} ( i , k )} \\ \end{matrix} & ( 8 ) \\ {\hat{\sum }}_{ik} = \frac{{\sum }_{t = 1}^{T} {{ζ}_{t} ( i , k ) [ {x}_{t} - {\hat{μ}}_{ik} ] [ {x}_{t} - {\hat{μ}}_{ik} ]}^{T}}{{\sum }_{t = 1}^{T} {ζ}_{t} ( i , k )} & ( 9 )\end{matrix}$$

Equation 9 re-estimates the k'th component of the i'th state Gaussian mixture model mean vector and covariance matrix. For a semi-continuous HMM, these components are shared over multiple states. Integrating out the state dependency from ζₜ(i,k), gives the semi-continuous model estimates as shown in equations (10) to (12) below:

$$\begin{matrix} {ζ}_{t} ( k ) = {\sum }_{i} {ζ}_{t} ( i , k ) & ( 10 ) \\ {\hat{ μ}}_{k} = \frac{{\sum }_{t = 1}^{T} {ζ}_{t} ( k ) {x}_{t}}{{\sum }_{t = 1}^{T} {ζ}_{t} ( k )} & ( 11 ) \\ {\hat{\sum }}_{k} = \frac{{\sum }_{t = 1}^{T} {{ζ}_{t} ( k ) [ {x}_{t} - {\hat{μ}}_{ik} ] [ {x}_{t} - {\hat{μ}}_{ik} ]}^{T}}{{\sum }_{t = 1}^{T} {ζ}_{t} ( k )} & ( 12 )\end{matrix}$$

The above estimates for the general model parameters can be used to modify the feature vectors (e.g., four feature vectors). The set η(xₜ) can be different for each of the feature vectors, hence the output probability can be calculated according to equation (13) below:

$${o}_{s} ( {x}_{t} ) = {\prod }_{f = 1}^{4} {\sum }_{k ∈ {ν}_{f} ( {x}_{t} )} {w}_{{sf}_{k}} {N}_{f} ( {x}_{t} \text{\vert} {μ}_{{f}_{k}} , {\sum }_{{f}_{k}} ) \qquad ( 13 )$$

To determine a new estimate for û_{f}_{ₖ} the system integrates out the contributions of the other features to the posterior distribution ζₜ(k) to derive an estimate. Applying the relationship between this distribution and the forwards and backwards probabilities, αₜ(i) and βₜ(i):

$${ζ}_{t} ( k ) = {\sum }_{i} {ζ}_{t} ( i , k ) = \frac{{\sum }_{i} {\sum }_{j} {α}_{t - 1} ( i ) {a}_{ij} {o}_{j} ( {x}_{t} ) {β}_{t} ( j )}{{\sum }_{i} {α}_{T} ( i )} \qquad ( 14 )$$

where aᵢⱼ is the HMM's state-to-state transition probability. Integrating out all but feature f′ yields:

$${ζ}_{t} ( {f}_{k}^{′} ) = \frac{{\sum }_{i} {\sum }_{j} {α}_{t - 1} ( i ) {a}_{ij} [ {\prod }_{f \neq {f}^{′}}^{4} {\sum }_{k ∈ {η}_{f} ( {x}_{t} )} {w}_{{sf}_{k}} {N}_{f} ( {x}_{t} \text{\vert} {μ}_{{f}_{k}} , {\sum }_{{f}_{k}} ) ] {w}_{{sf}_{k}^{′}} {N}_{{f}^{′}} ( {x}_{t} \vert {μ}_{{f}_{k}^{'}} , {Σ}_{{f}_{k}^{'}} ) {β}_{t} ( j )}{{\sum }_{i} {α}_{T} ( i )} \qquad ( 15 )$$

These probabilities can be substituted into the equations for ML mean vector and covariance matrix estimation given above.

The rapid adaptation algorithm also includes a MAP model estimation. During the model estimation the arithmetic mean and covariance vectors of the ML and speaker-independent (SI) models are combined according to the posterior probabilities ζₜ(fₖ) and a hyper-parameter λ shown in equations (16) and (17) below:

$$\begin{matrix} {\hat{μ}}_{{f}_{k}}^{MAP} = \frac{{μ}_{{f}_{k}}^{SI} {λ}_{μ} + {\hat{μ}}_{{f}_{k}}^{ML} {\sum }_{t = 1}^{T} {ζ}_{t} ( k )}{{λ}_{μ} + {Σ}_{t = 1}^{T} {ζ}_{t} ( k )} & ( 16 ) \\ {\hat{\sum }}_{{f}_{k}}^{MAP} = \frac{{\sum }_{{f}_{k}}^{SI} {λ}_{\sum } + {\hat{\sum }}_{{f}_{k}}^{ML} {\sum }_{t = 1}^{T} {ζ}_{t} ( k )}{{λ}_{\sum } + {Σ}_{t = 1}^{T} {ζ}_{t} ( k )} & ( 17 )\end{matrix}$$

The hyper-parameter values for passages of around 200 words of training data can be approximately set such that λᵤ is in the range of 1.0e-4 to 5.0e-2 (e.g., λμ=2.0e-4) and λ_{Σ} is in the range of 1.0e-4 to 5.0e-3, (e.g., λ_{Σ}=3.0e-4).

Thus, based on a limited amount of user voice data, the custom voice model is adapted for the user by adjusting the arithmetic means and variances of the underlying Gaussian functions in the voice model.

The use of voice models adapted to the user's speech can reduce false negative interventions and increase the number of errors caught by the application. For speakers who match the acoustic model well this can be observed in a reduction in the Gaussian variances across the model.

The process for collecting voice data used to generate a custom voice model is uniquely designed for children, hence the instructive user interface. Because the children may mis-speak during the collection phase, the output of the forward backward algorithm can be analyzed to ensure that the observed word sequence approximately or closely matches the recorded data. This is accomplished by checking the best terminating state matched against the audio data is within the last five states of the HMM of the last word of the recognized sequence. If the audio data is not within five states, the utterance is discarded.

A number of embodiments of the invention have been described. Nevertheless, it will be understood that various modifications may be made without departing from the spirit and scope of the invention. Accordingly, other embodiments are within the scope of the following claims.

What is claimed is:

1. A method for generating a custom voice model, the method comprising:
receiving audio input from a user;
comparing the received audio input to an expected input that is determined based on an initial or default voice model;
determining a number of words read incorrectly in a sentence of the passage; and
adding the sentence audio data to the set of data for producing the custom voice model if the number of words read incorrectly is less than a threshold value.

2. The method of claim 1 further comprising determining a number of words read incorrectly based on a subset of words from the passage.

3. The method of claim 1 further comprising signaling the user to re-read a sentence if the number of words read incorrectly is greater than the threshold value.

4. The method of claim 3 further comprising playing a recorded reading of the sentence, and indicating that the user should repeat what they hear, as part of signaling the user to re-read a sentence if the number of words read incorrectly is greater than the threshold value.

5. The method of claim 3 further comprising:
receiving input from the user related to the re-read sentence;
determining a number of words read incorrectly in the re-read sentence;
proceeding to the next sentence without adding the re-read sentence audio data to the set of data for producing the custom voice model, if the number of words read incorrectly is greater than the threshold value.

6. The method of claim 4 further comprising determining the number of sentences that have not been included in the set of data for producing the custom voice model, and aborting the process of generating a custom voice model if this number exceeds a threshold.

7. The method of claim 5 further comprising playing a recorded reading of a sentence based upon user request, either before the user starts reading the passage or after the user has requested to pause the reading of the passage and associated audio collection.

8. A method for generating a custom Gaussian voice model, the method comprising:
determining, based on an existing voice model, if a received audio input matches an expected input that is represented by a set of phonemes with at least some of the phonemes represented by a by a sequence of Hidden Markov Model (HMM) states whose output distributions are represented by a weighted mixture of gaussian or normal distribution, with each of the distribution parameterized by a mean vector and covariance matrix;
decomposing the received audio input into phonemes; and
analyzing the phonemes to adjust at least one of the variance and the arithmetic mean without adjusting the weight factor of the Gaussian for at least one of the Gaussian functions to produce the custom Gaussian voice model; and
storing the custom Gaussian voice model.

9. The method of claim 8 wherein receiving audio input includes receiving less than about 100 words of audio input.

10. The method of claim 8 wherein analyzing adjusts both the variance and the arithmetic mean.

11. The method of claim 8 wherein analyzing includes calculating a new variance and arithmetic mean based on the received audio.

12. The method of claim 11 wherein analyzing includes calculating a new variance and arithmetic mean based on the received audio; and
merging the calculated variance and arithmetic mean with the original variance and arithmetic mean for the Gaussian to determine a custom voice model.

13. A device configured to:
receive audio input from a user;
compare the received audio input to an expected input that is determined based on an initial or default voice model;
determine a number of words read incorrectly in a sentence of the passage; and
add the sentence audio data to the set of data for producing a custom voice model if the number of words read incorrectly is less than a threshold value.

14. The device of claim 13 further configured to determine a number of words read incorrectly based on a subset of less than all of words from the passage.

15. The device of claim 13 further configured to signal the user to re-read a sentence if the number of words read incorrectly is greater than the threshold value.

16. The device of claim 15 further configured to receive input from the user related to the re-read sentence;
determine a number of words read incorrectly in the re-read sentence;
proceed to the next sentence without adding the re-read sentence audio data to the set of data for producing the custom voice model, if the number of words read incorrectly is greater than the threshold value.

17. A device configured to:
determine if a received audio input matches an expected input that is represented by a set of phonemes with at least some of the phonemes represented by a plurality of Gaussian functions with each of the Gaussian functions having a weight factor, an arithmetic mean, and a variance;
decompose the received audio input into phonemes; and
analyze the phonemes to adjust at least one of the variance and the arithmetic mean without adjusting the weight factor of the Gaussian for at least one of the Gaussian functions for a particular phoneme to produce the custom Gaussian voice model; and
store the custom Gaussian voice model.

18. The device of claim 17 further configured to adjust both the variance and the arithmetic mean.

19. The device of claim 17 further configured to calculate a new variance and arithmetic mean based on the received audio.

20. The device of claim 17 further configured to calculate a new variance and arithmetic mean based on the received audio; and
average the calculated variance and arithmetic mean with the original variance and arithmetic mean for the Gaussian to determine a custom voice model.

21. A computer program product, tangibly embodied in an information carrier, for executing instructions on a processor, the computer program product being operable to cause a machine to:
receive audio input from a user;
compare the received audio input to an expected input that is determined based on an initial or default voice model;
determine a number of words read incorrectly in a sentence of the passage; and
add the sentence audio data to the set of data for producing a custom voice model if the number of words read incorrectly is less than a threshold value.

22. The computer program product of claim 21 further configured to determine a number of words read incorrectly based on a subset of less than all of the words from the passage.

23. The computer program product of claim 21 further configured to signal the user to re-read a sentence if the number of words read incorrectly is greater than the threshold value.

24. The computer program product of claim 23 further configured to receive input from the user related to the re-read sentence;
determine a number of words read incorrectly in the re-read sentence;
proceed to the next sentence without adding the re-read sentence audio data to the set of data for producing the custom voice model, if the number of words read incorrectly is greater than the threshold value.

25. A computer program product, tangibly embodied in an information carrier, for executing instructions on a processor, the computer program product being operable to cause a machine to:
determine if a received audio input matches an expected input that is represented by a set of phonemes with at least some of the phonemes represented by a plurality of Gaussian functions with each of the Gaussian functions having a weight factor, an arithmetic mean, and a variance;
decompose the received audio input into phonemes; and
analyze the phonemes to adjust at least one of the variance and the arithmetic mean without adjusting the weight factor of the Gaussian for at least one of the Gaussian functions for a particular phoneme to produce the custom Gaussian voice model; and
store the custom Gaussian voice model.

26. The computer program product of claim 25 further configured to adjust both the variance and the arithmetic mean.

27. The computer program product of claim 25 further configured to calculate a new variance and arithmetic mean based on the received audio.
